(19) United States
(12) Patent Application Publication
(10) Pub. No.: US 2008/0065516 A1
(43) Pub. Date: Mar. 13, 2008

(54) Method for tire line category management

(76) Inventors: Vinod Pius Raju, Uniontown, OH (US); Alvaro Enrique Mendoza, Copley, OH (US); Garey Patrick Smiley, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/517,665

(22) Filed: Sep. 8, 2006

(51) Int. Cl. G06Q 10/00

(52) U.S. Cl. 705/28

(57) ABSTRACT

A method for tire line category management for a retail store includes: defining corporate strategy and tactics for the tire category, including selecting a set of performance metrics; collecting data for the tire category on an SKU by SKU basis; conducting a tire line review for each tire line or SKU; including weighting each SKU based on the pre-selected set of metric variables; implementing store level stocking solutions based on each SKU's weighted set of metric variables; monitoring results on a tire SKU-by-SKU basis; and repeating the process as needed in view of tire line results. The metric variables used in profiling each SKU are from the group: brand/line aligned to market; tracking the market; SKU density; store density; sales units; sales dollars; gross margin; gross margin return on investment; inventory turns. The metric variables are weighted and combined to form a weighted SKU metric score.

### FIELD OF THE INVENTION

The invention relates generally to a method of product line review and, more particularly, to a method for determining an optimal assortment of products in a multi-line product offering in order to achieve sales and profit goals.

### BACKGROUND OF THE INVENTION

In any multi-product and multi-category offering, it is important to determine an optimal assortment of products in a retail mix that will result in desired sales and profit. In the sale of a product such as tires, retail sales may occur through alternative channels such as multi-category, large regional, car dealership, and independent tire dealer retailers. Each retailer within each channel typically develops goals for the tire product category and strategies for achieving such goals. On a periodic basis, the performance of the category is reviewed to determine whether the category has met its intended goals. Should the category fall short, adjustments may be made in the product or brand mix in an attempt to correct the category performance.

Heretofore the product category management of tires by various retail channels has been intuitively based, lacking a controlled methodology that can objectively assist in evaluating product category performance and provide recommendations as to the optimal product mix that will achieve the best results. Moreover, a methodology has been lacking that can quantitatively evaluate a product category by means of vital metric categories tied specifically to a given retailer strategy. As such, current available category management techniques are less than adequate as a tool for achieving desired sales and profit goals.

### SUMMARY OF THE INVENTION

The present invention provides a category management method capable of recommending an optimal assortment of products in a top-down corporate-wide line review and/or a store-by-store stocking solution in a bottom-up approach. According to one aspect of the invention, a method for tire line category management includes: defining corporate strategy and tactics for the tire category including defining a set of metrics for the category; collecting data for the tire category on a SKU by SKU basis; conducting a tire line review for each SKU, weighting each SKU on the preselected set of metric variables; determining a store stocking solution based upon the weighted metrics of each SKU, implementing the store level stocking solution; monitoring results; and repeating the method as needed in view of tire SKU results.

According to another aspect of the invention, the tire line review includes setting at a corporate level an assortment of tire products to be sold; identifying tire lines and SKU's to add, delete, minimize, and maximize; and setting product screen rules. In another aspect of the invention, the metric variables used in evaluating each SKU are from the group: brand/line aligned to market; tracking the market; SKU density; store density; sales units; sales dollars; gross margin; gross margin return on investment; inventory turns. The metric variables used in profiling the retail store are weighted to define a custom weighted store profile and the performance of each tire line/SKU may be evaluated against the store's custom weighted profile. The method may be used in a single store construct or in a multi-store, multi-channel organization.

### BRIEF DESCRIPTION OF THE DRAWINGS

The invention will be described by way of example and with reference to the accompanying drawings in which:

FIG. 1 is a pictorial representation of a conceptual roadmap illustrating retail strategy resulting from utilization of the subject category management method;

FIG. 2 is a retail strategy example a multi-category retailer graphing sales over time and superimposed graph of a new product introduction.

FIG. 3 is a retail strategy example for a tire retailer graph similar to FIG. 2, and a superimposed graph of a new product introduction.

FIG. 4 is a segmented circular chart illustrating one possible set of metrics that may be utilized according to the principles of the invention.

FIG. 5 is an example of the subject scoring system showing allocation of points among the metric categories of FIG. 4 and a pictorial representation of the metric weighting in accordance with the allocation of points.

FIG. 6 is a graph for a multi-category retailer graphing sales over time and a pictorial representation of the store-based strategy differentiation.

FIG. 7 is a graph for a tire retailer graphing sales over time and a pictorial representation of the retailer based strategy differentiation.

FIG. 8 is a block level diagram of the subject category management method.

FIG. 9A is a category management overview top-down approach utilizing the subject category management method.

FIG. 9B is a category management overview bottom-up approach utilizing the subject category management method.

FIG. 10A is a chart showing application of the subject method to a first tire of specified size, and the metric weighting for that tire.

FIG. 10B is a chart showing application of the subject method to a second tire of different size, and metric weighting for that tire.

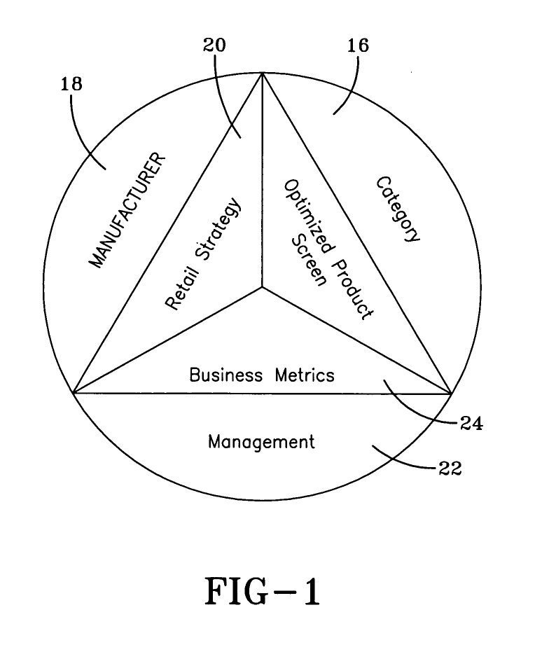

### DETAILED DESCRIPTION OF THE INVENTION

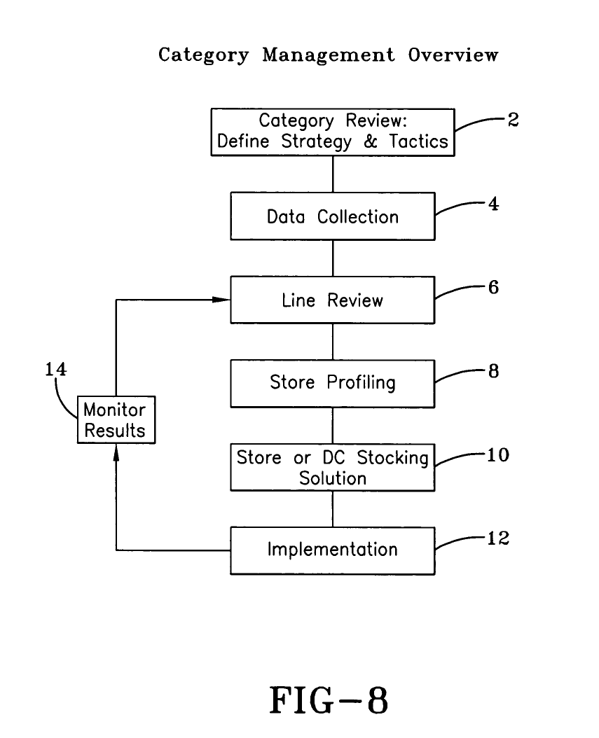

Referring first to FIG. 8, the subject category management method is shown in block level diagram as including the steps: category review 2 in which strategy and tactics are defined; collecting data 4; reviewing the product line 6 to be managed; profiling the store(s) 8; deriving a store stocking solution 10; implementing the stocking solution 12; and monitoring results 14 to determine if the results are achieving the desired sales, profitability, and inventory goals. In the event that the goals are not advanced to an optimal level, the process is repeated by conducting a re-review 6 of the line.

In general, the subject category management method is intended to manage a retailer's marketing mix; that is, the product selection to be offered; the price of the product; the promotion of the line; and the place where the product is offered. The subject method is capable of utilization in any multi-line, multi-supplier product category, such as but not limited to tires. In the tire category, tires are offered in various sizes and price points at the retail level. There are alternative suppliers of tires and a retailer must mix tire products of the various suppliers in a manner that will optimize sales and profitability of the product category while managing inventory of each tire in order to minimize inventory costs.

Consumer needs and the competitive environment in the tire market is considered in conjunction with the marketing mix. In a category management process, it is important that the process be capable of execution at the local level since geographically separated retail establishments within a multi-store business may encounter store-to-store differences in consumer needs and competitive environment. In addition, an acceptable category management involves the overall tire category, is neutral and impartial, and can be insulated from other business units and management of other categories. If successful, the category management will provide the retailer with individual store stocking recommendations; improved inventory management; and improved sales, cash flow, and profit optimization. For the product manufacturer, a successful management of a product category ensures the right products for the retailer, increases the manufacturer's sales and profits; and improves forecasting and manufacturing efficiencies.

The subject category management process can be automated and institutionalized. It further can handle variable complexity and may be scaled and ported with minimal effort to both large and small customers. It is customized to be customer-specific and customer strategy specific, resulting in an optimized product line, positioned at the right price; sold at the correct stores, catering to the needs of the local consumer.

The tire category will be used as an example herein, it being understood that the process may be implemented for other product categories as well. Tires are sold in unique tire sizes that address vehicle specifications. A tire will have a unique combination of load index, rim diameter, speed rating, aspect ratio, section width, and construction type. As a result, a given retailer will carry a plurality of tire SKU's (stock keeping units). Tires may be sourced from one supplier but, more typically, the tire product line is a selective combination of tires from multiple tire suppliers.

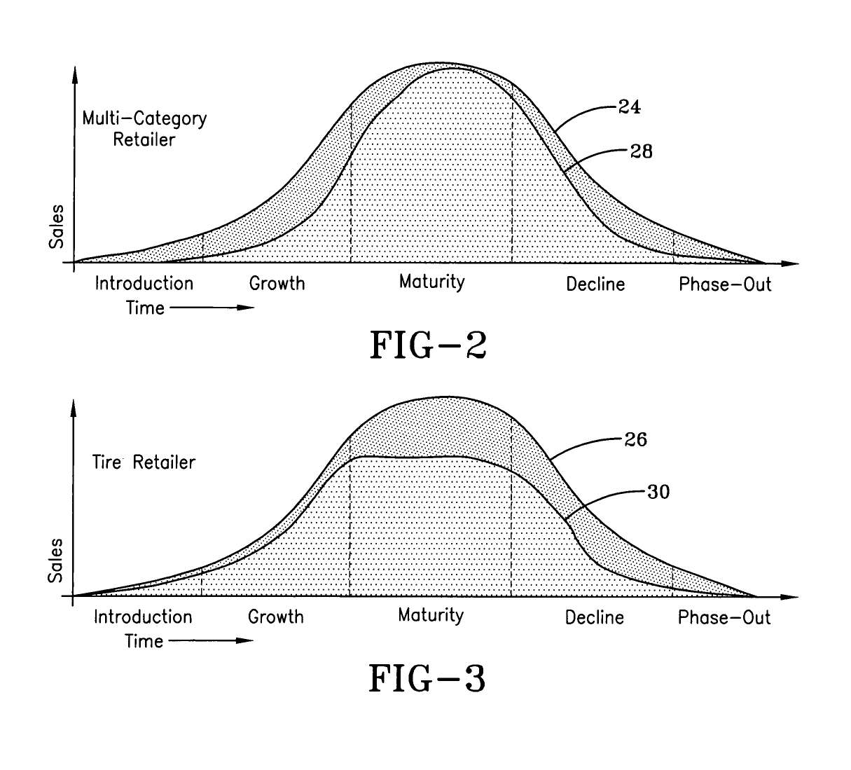

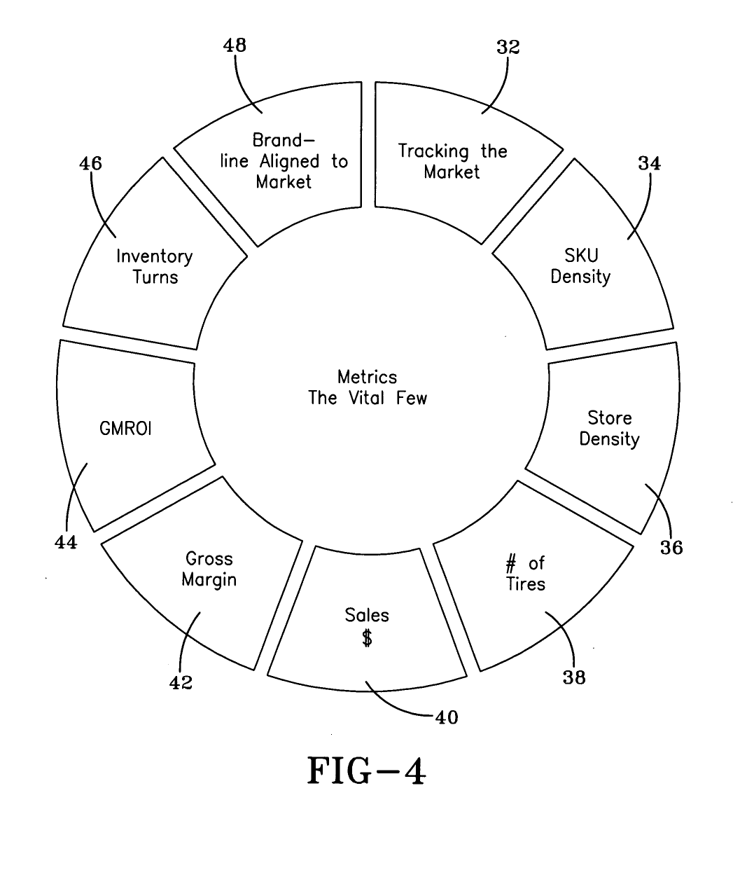

FIGS. 2 and 3 illustrate in graphic form a comparison of new tire SKU introduction for a multi-category retailer (FIG. 2) and a tire retailer (FIG. 3). As shown in the graphs, a new product SKU in general will follow a curve 26 beginning with product introduction, and sequencing through a growth, maturity, decline, and phase-out. A new product, in general, is shown as following a bell-shape curve 26. A particular new product, however, may not strictly follow the general new product curve 26 but, rather, follow an irregular curve 28, 30 as shown in FIGS. 2 and 3, respectively. The new products following curves 28, 30 will still undergo introduction, growth, maturity, decline, and phase-out. However, the timing and shape of the curves will be unique to the product and will be influenced by myriad market and corporate factors.

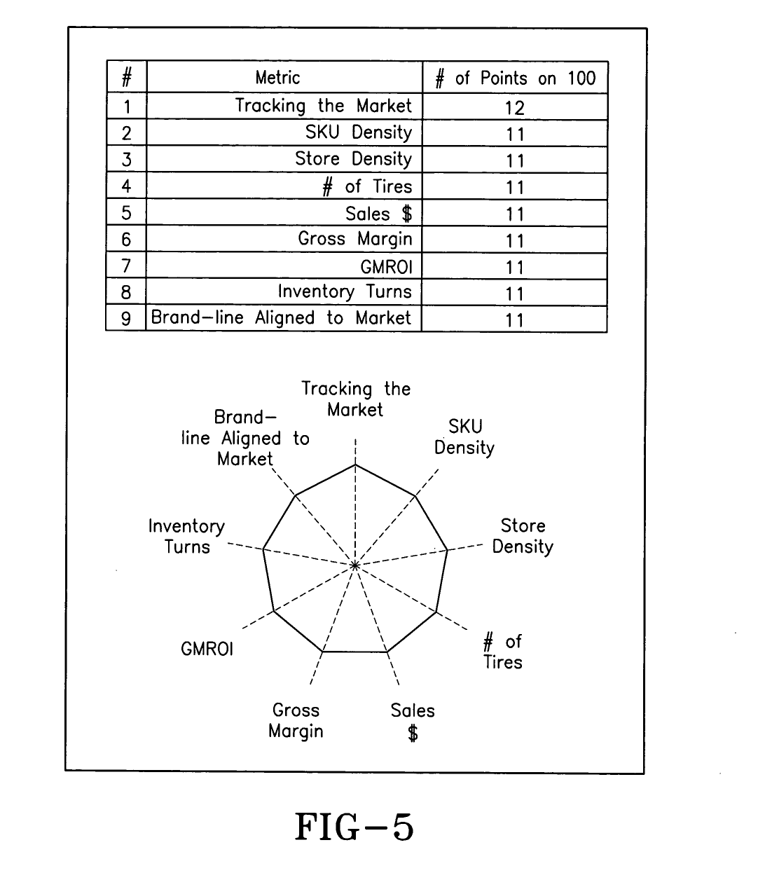

In order to account for the unique aspects of a SKU or product in a product mix that will affect the performance and goals of the retailer, a set of metric variables is identified pursuant to the subject category management process. FIG. 4 illustrates one set of metrics that may be utilized in evaluating each SKU in a product category offering. More or fewer metric factors may be used if desired without departing from the invention. As shown in FIG. 4, by way of example, the metrics selected are: tracking the market 32; SKU Density 34; Store Density 36; Number of Tires 38; Dollars of sales 40; Gross Margin 42; GMROI (gross margin return on investment) 44; inventory turns 46; and brand/line aligned to market 48. A weighting scale is used that may be customized to fit the strategy and objectives of the retailer. For example, as shown in FIG. 5, a total number of points may equal 100. There are nine metrics identified in FIGS. 4 and 5. A number out of the 100 total points may be assigned to each of the nine metrics. In FIG. 5, the number of points is relatively the same for each metric, resulting in the pictorial graph of point distribution at the bottom of FIG. 5.

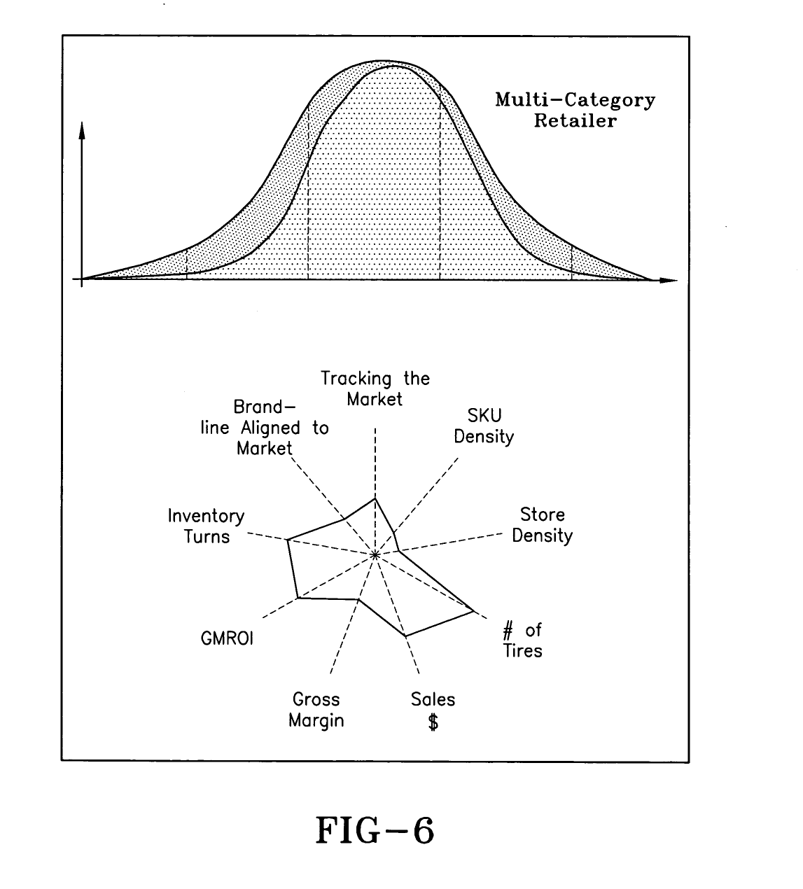

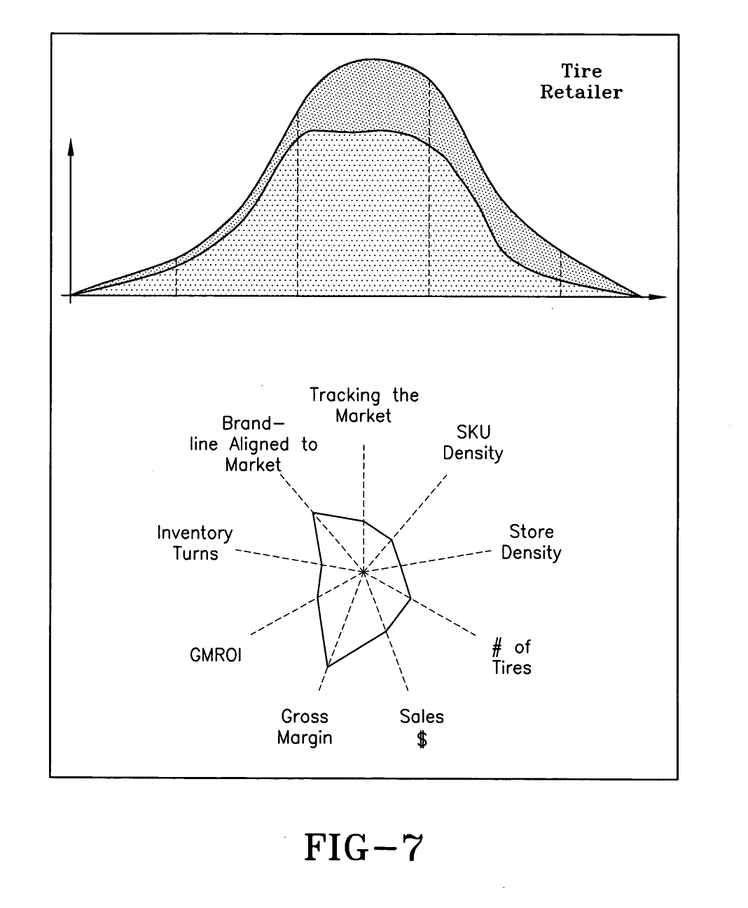

Each SKU or product category (e.g. tire size) will have a customized distribution of points among the nine metric categories, depending on the strategies and objectives of the business. Some may have a roughly equal distribution such as in FIG. 5. Others, for strategy and business reasons, may skew the point distribution, resulting in a pictorial distribution such as shown in the bottom of FIG. 6. It will be noted that, for example, the number of tires metric is weighted more heavily than store density. For a multi-category retailer, the map of each SKU will be customized by means of metric weighting in order to achieve pre-selected company goals and objectives. The actual results of the SKU against the plan can then be reviewed and evaluated and a decision reached on whether that particular SKU is contributing positively toward meeting goals and objectives.

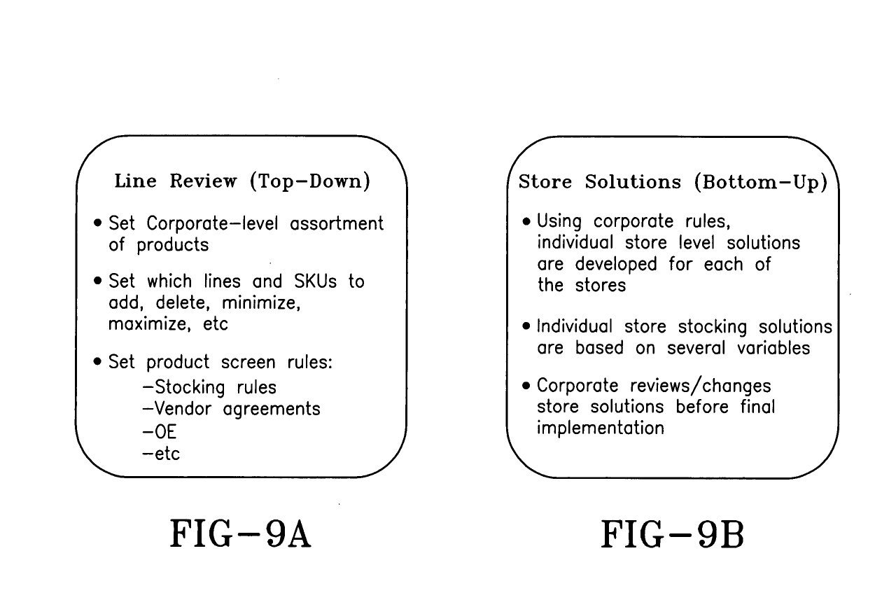

Referring to FIGS. 8, 9A and 9B, the subject Category Management process may be conducted either on a top-down basis or a bottom-up basis in defining category strategy and tactics 2. In a top-down approach, all stores are rolled into one corporate assortment of products and one product screen is done for all stores. Thus, at a corporate level, one assortment of products will be specified and the metric map of each SKU will be selected on a corporate-wide basis. In the bottom-up approach, a product screen will be conducted for each store individually, with each store setting metric weighting in accordance with each store's unique goals and objectives.

The category review 2 is conducted so as to define market segments to serve, uncover missed opportunities and areas to reinforce, establish brand strategy, and propose the set of metrics that will be utilized.

Data is collected (step 4 in FIG. 8) at the retail store level relevant to the metrics selected such as sales history by store; SKU's, units, revenue. Metrics are defined. For the example, nine metrics identified in FIG. 4 may be used and, for each SKU, data pertaining to the nine metric categories collected at the retail store level. The menu of metrics utilized must be aligned to the retailer strategy. For example, if the desired business result is to increase sales/margin, reduce lost sales, optimize product mix, etc., then appropriate metrics that are selected may include: same store sales (units and dollars); margin dollars increase; revenue per tire; profitability per tire; mix improvement. Should the retailer strategy be to increase cash flow, one possible metric set may include: in stock percent; fill rate percent; weeks on hand; inventory turns; GMROI; and GMROS. Still further, should the retail strategy be to reduce business complexity, a metric set may include: number of SKU's; number of tire lines; or number of SKU's per tire size.

From FIG. 8, the process proceeds as a line review 6 is conducted. In the top-down approach, a corporate-level assortment of products is specified. The corporation sets the lines and SKU's to add, delete, minimize, maximize, etc. Corporate-wide product screen rules are set, such as stocking rules, vendor agreements, etc. The goal in the top-down approach is one standardized assortment of products. In the bottom-up approach, using corporate rules, individual store level solutions are developed for each of the retail stores. Individual store stocking solutions are based on variables unique to each store such as geography, demographics, consumer preferences, vehicle population, and sales history. A modifiable stocking solution for each store is constructed. Review/changes of each store solution may be conducted at the corporate level before final implementation. The goal in the bottom-up approach is individual customized store stocking solutions.

The line review will establish an optimal set of tire sizes and SKU's aligned with the retailer's retail strategy as discussed above. Individual store stocking solutions will be created and each SKU will be measured and rated as part of a product screen. In so doing, it will be possible to objectively flag SKU's for maintenance, replacement, elimination, or addition. Each SKU is rated for allocation in the store stocking solution by comparison among all SKU's and/or comparison among SKU's in the same tire size based on their performance (metrics).

Weighting of each metric within a retail strategy will be appreciated with reference to FIG. 4. The example of FIG. 4 is a set of nine metrics, each metric having points assigned from 1-10. Tracking the Market 32 is a metric that reflects how tire unit volume at a retailer is behaving compared to the Industry. Industry available tire sales data is used to determine what percent of unit volume a retailer is achieving for a tire size. A high number of points assigned for this metric indicates that the SKU or tire size strongly tracks the market.

The metric SKU Density 34 is used as an indicator of whether a retailer has a sufficient number, too many, or too few SKU's in a tire size. The number of tires size and the number of SKU's is determined. The ratio of units per SKU is calculated. A high number of units per SKU will result in a higher weight number (scale 1-10) assigned to that SKU while a lower number may identify the SKU as a candidate for rationalization.

The metric Store Density is used as an indicator of whether a retailer has an SKU in too many or too few stores. SKU's in a group of stores for a given tire size may be determined and the density (units per store) calculated. A high ratio of units per store indicates high SKU density and a high weight (in the scale 1-10) would be assigned to that SKU. A low number would indicate a low SKU density and the SKU could potentially be a candidate for rationalization.

The metric Sales Units 38 in FIG. 4 measures total unit sales. A maximum number of points in the 1-10 weighting is assigned to the number one unit tire size or SKU. Likewise, a minimum number of points is assigned to the bottom selling unit tire size or SKU.

The metric Sales Dollars 40 measures total dollar sales, a maximum number of points in the 1-10 scale being assigned to the number one unit tire size or SKU having the highest dollar sales and a lesser number of points to the bottom selling unit tire sizes or SKU's.

The metric Gross Margin measures total Gross Margin with points assigned to the unit tire sizes or SKU's based on their relative Gross Margin levels. Similarly, allocation of points based on the metric Gross Margin Return on Investment (GMROI) is on the basis of relative GMROI performance. A maximum number of points is assigned to the best Inventory Turns unit tire size or SKU and a minimum number of points to the worse Inventory Turns in metric 46. For the metric Brand-line Aligned to Market 48, the unit tire size or SKU market positioning is compared to the market. A comparison is made to unique tire size or SKU positioning of the entire industry to determine whether any deviations exist. The closer to market position, the higher the number of points given in the 1-10 metric weighting.

The nine metrics may be categorized as basic category management metrics, metrics relative to the tire industry, and rationalization metrics. In the basic category management metric category, volume, revenue, gross profit, GMROI and turns metrics are used. In the category of metrics relative to the tire industry, market tracking and brand strategy positioning would fall. SKU density and Store Density would be within the rationalization metric category.

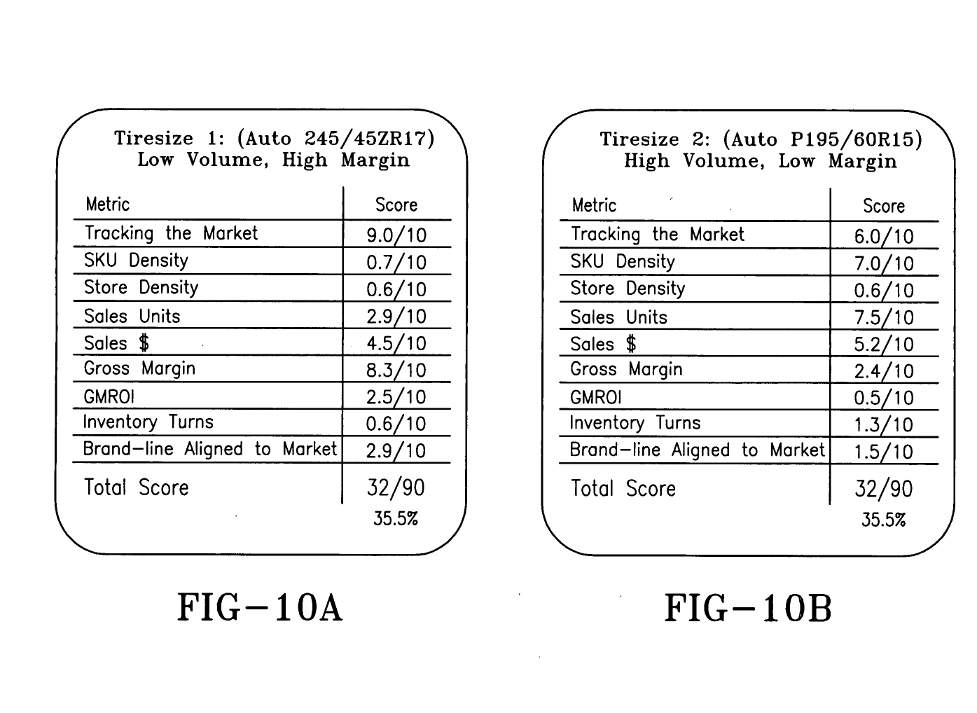

FIGS. 10A and 10B show as an example a comparison of metric weights for two unique tire sizes or SKU's. The tire in FIG. 10A is a low volume, high margin tire while that of FIG. 10B is a high volume, low margin tire. It will be noted that the scores of each tire are different metric to metric but the total score (32/90) is the same for both. The strategy of the retailer, set in step 2 of FIG. 8, will determine what stocking level of each tire will best optimize the product mix of the store and best meet the objectives and goals of the strategy. For example, tire size 1 has a high metric for tracking the market while tire size 2 is lower. If the retail strategy is to emphasize products that track the market strongly, tire size 1 would be at an advantage in such a strategy.

Referring to FIG. 8, the store profiling step 8 is conducted by calculating trade areas and determining vehicle population and tire size potentials for each store. It will be appreciated that the composition of vehicle population and, therefore, tire sizes, vary geographically and demographically. An analysis of each store relative to special geographic and demographic factors is made as to how such factors will ultimately affect the store stocking solution in step 10. Adjustment of the metric weights assigned to the unique tire size or SKU may be necessary in view of special store factors.

The step of Store or DC (? What does this stand for?) Solutions 10 involves configuring stocking recommendations for each store using metrics, capacity, frequency of restocking and delivery, potential market and sales history. A review and modification of recommendations may be made as needed. An allocation of SKU's from the results of the Line Review step 6 will be made to each store, adjusted for the store's local characteristics. As a result, the SKU mix will optimize the store's alignment to the local market. SKU optimization may maintain stocking level of an SKU; increase the stocking level; decrease the stocking level; make the SKU a Special Order case in which the SKU is offered to customers on an as-ordered basis; substitute the SKU with a better performing SKU; combine similar performance, similar price and product characteristic SKU's into one SKU.

The store or DC stocking solution 10 is implemented in step 12 by adjusting store stocking levels and moving discontinued SKU's. The results are monitored at step 14 which feeds back to the line review step 6. If the results do not meet expectations, the method beginning with the line review 6 is repeated and further adjustments are made. The method is, accordingly, an ongoing process capable of adapting to changing markets or corporate strategies. The invention may be used at a local retailer level or implemented on a corporate-wide basis. In addition, the strategies may be uniform throughout a multi-store company or may be varied store-to-store or region-to-region to meet local store characteristics and market factors. The selection of metrics may be tailored to meet the needs of a particular company strategy or in response to category-unique factors. By customizing the metric variables used in the process, the method is capable of placing the category management process in alignment with company or retail store strategy. The stocking solution is thus optimized and continuously monitored and evaluated as an on-going process. Finally, the weighting of each unique tire size or SKU is according to a standardized set of custom metrics, making a comparison of the performance of one SKU against another more objective and allowing for a more objective evaluation and rationalization to occur.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for tire category management for at least one tire retail store, comprising:
a. defining a strategy and tactics for the tire category, including selecting a group of category metric variables;
b. collecting data on a tire line on an SKU by SKU basis;
c. conducting a tire line review, weighting each SKU on the selected group of metric variables;
d. profiling the retail store
e. deriving a customized store level stocking solution using the weighted SKU metric variables adjusted by the retail store profile;
f. implementing store level stocking solutions;
g. monitoring results on an SKU by SKU basis; and
h. repeating steps d, e, f, as needed in view of results.

2. The method according to claim 1 wherein the tire line review for each tire line comprises:
setting an assortment of tire SKU's to be sold;
identifying tire lines and SKU's to add, delete, minimize, and maximize;
setting product screen rules.

3. The method according to claim 1 wherein the metric variables used in the tire line review are from the group: brand/line aligned to market; tracking the market; SKU density; store density; sales units; sales dollars; gross margin; gross margin return on investment; inventory turns.

4. The method according to claim 3, wherein the metric variables for each SKU in the tire line review are weighted and added together to derive an SKU metric score.

5. The method according to claim 4, wherein the store level stocking solution is based upon evaluating weighted metric scores of each SKU relative to other SKU's.

6. The method according to claim 1, wherein a custom weighted store profile of metric variables is utilized for evaluating results on an SKU by SKU basis.
